(19) United States
(12) Patent Application Publication
(10) Pub. No.: US 2025/0156746 A1
(43) Pub. Date: May 15, 2025

(54) POST-PROCESSING DIFFERENTIALLY PRIVATE SYNTHETIC DATA

(71) Applicant: International Business Machines Corporation, Armonk, NY (US)

(72) Inventors: Hao Wang, Cambridge, MA (US); Shivchander Sudalairaj, Cambridge, MA (US); Akash Srivastava, Boston, MA (US)

(73) Assignee: International Business Machines Corporation, Armonk, NY (US)

(21) Appl. No.: 18/505,571

(22) Filed: Nov. 9, 2023

(51) Int. Cl. G06N 20/00

(52) U.S. Cl. CPC G06N 20/00

(57) ABSTRACT

An embodiment generates, using a probability distribution of synthetic data, a first value of a utility measure function, and a second value of the utility measure function, a value of an optimization variable, the synthetic data generated from a source dataset using a differential privacy technique, the utility measure function measuring a characteristic of a dataset. An embodiment computes, using the value of the optimization variable, a sampling weight, the sampling weight comprising a probability of selecting a portion of data from the synthetic data. An embodiment samples, according to the sampling weight, the synthetic data, the sampling resulting in a sampled synthetic dataset. An embodiment trains, using the sampled synthetic dataset, a machine learning model, the training resulting in a trained machine learning model.

### STATEMENT REGARDING PRIOR DISCLOSURES BY THE INVENTOR OR A JOINT INVENTOR

WANG et al., Post-processing Private Synthetic Data for Improving Utility on Selected Measures, 24 May 2023.

### BACKGROUND

The present invention relates generally to data privacy. More particularly, the present invention relates to a method, system, and computer program for post-processing differentially private synthetic data.

A dataset or database is a logical container used to organize and control access to resources such as stored data. A dataset typically includes one or more tables. A table stores data values using a model of labelled columns (also referred to as variables or fields) and rows (also referred to as records). A cell of the table is an intersection of a row and a column. Typically, column labels designate a particular type of data (for example, a table might have columns labelled “Customer ID”, “Name”, “Address”, and “Telephone Number”), and rows hold data for particular individuals (e.g., data for Customer A might be stored in row 1 and data for Customer B might be stored in row 2).

Data simulation, or artificial data generation, or synthetic data generation, is a process of generating artificial data that mimics the characteristics and patterns of real-world data. Synthetic data generation is often used to generate training and testing data for use in developing machine learning models and in other situations where insufficient real-world data is available for use. Data simulation is typically performed by fitting a parametric statistical distribution to the observed data, and generating new data points from the fitted distribution. However, statistical analyses of data in a dataset can reveal information about a single individual in the dataset, particularly if an adversary knows information about other individuals in the dataset. Thus, privacy preserving data analysis and data simulation techniques, which attempt to make a dataset usable for analysis or generate artificial data using statistical information about a dataset, without compromising the privacy of any individuals with records in the dataset, have been developed.

One method of implementing privacy preserving data analysis is differential privacy, which hides the presence of an individual in a dataset from a user of the dataset by making two output distributions, one with and the other without the individual, be computationally indistinguishable (for all individuals). Data generated under a differential privacy mechanism or differential privacy technique is referred to as private synthetic data or a private synthetic dataset. A differential privacy mechanism or technique guarantees that even if an adversary observes a private synthetic dataset, the adversary cannot distinguish if a specific individual's data were ever used to generate the synthetic data, and prevents disclosure of a specific individual's data. As a result, a machine learning model can be trained on private synthetic data but then deployed, once trained, for use on real data.

A utility measure function measures a characteristic of a dataset. Some non-limiting examples of utility measure functions are a mean or average of the values in a particular column of a dataset, and a correlation coefficient between data in two columns of a dataset.

### SUMMARY

The illustrative embodiments provide for post-processing differentially private synthetic data. An embodiment includes generating, using a probability distribution of synthetic data, a first value of a utility measure function, and a second value of the utility measure function, a value of an optimization variable, the synthetic data generated from a source dataset using a first differential privacy technique, the utility measure function measuring a characteristic of a dataset. An embodiment includes computing, using the value of the optimization variable, a sampling weight, the sampling weight comprising a probability of selecting a portion of data from the synthetic data. An embodiment includes sampling, according to the sampling weight, the synthetic data, the sampling resulting in a sampled synthetic dataset. An embodiment includes training, using the sampled synthetic dataset, a machine learning model, the training resulting in a trained machine learning model. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for loading of process software in accordance with an illustrative embodiment;

FIG. 3 depicts a block diagram of an example configuration for post-processing differentially private synthetic data in accordance with an illustrative embodiment;

FIG. 4 depicts optimization problems for use in post-processing differentially private synthetic data in accordance with an illustrative embodiment;

FIG. 5 depicts a computation technique for use in post-processing differentially private synthetic data in accordance with an illustrative embodiment;

FIG. 6 depicts another computation technique for use in post-processing differentially private synthetic data in accordance with an illustrative embodiment;

FIG. 7 depicts an example of post-processing differentially private synthetic data in accordance with an illustrative embodiment; and

FIG. 8 depicts a flowchart of an example process for post-processing differentially private synthetic data in accordance with an illustrative embodiment.

### DETAILED DESCRIPTION

The illustrative embodiments recognize that those responsible for training machine learning models use a standardized model training pipeline that is difficult to adapt to the use of private synthetic data. While there are synthetic data generation techniques available for use under differential privacy, these techniques often optimize a generic class of loss functions during data generation. As a result, the generated data might not preserve a data characteristic (measured by a specific utility measure) needed to train a particular model, thus resulting in a model that does not meet a performance criterion and necessitating additional model training and testing. For example, some standardized model training pipelines rely on correlation coefficients between a model's output and one or more inputs, while some synthetic data generation techniques alter correlation coefficient values of the generated data. Workload-aware differential privacy methods aim to improve the privacy-utility trade-off by considering the specific workload or queries that will be applied to the data being generated, but these methods are inefficient as they need to fit a graphical model or a neural network to generate synthetic data. In addition, workload-aware differential privacy methods only evaluate the utility of the synthetic data by how well the synthetic data preserves known-in-advance statistics of the real data (e.g., 3-way marginals) of the real data. As a result, if the specific workload or queries that will be applied to the data being generated changes, the synthetic data will have to be regenerated. Public data-assisted methods generate private synthetic data by using public data. However, public data with similar characteristics to the private data must be available. In addition, some synthetic data generation techniques are computationally expensive for large datasets as they either require solving an integer program multiple times or need to solve a large-scale optimization problem. As well, some synthetic data generation techniques can introduce more noise to outlier data than to other data, potentially resulting in a disparate impact on an underrepresented population in the trained model.

Thus, the illustrative embodiments recognize that there is an unmet need to generate synthetic private data that preserves a data characteristic needed to train a particular model without requiring data regeneration when an end use of the data changes, that is more efficient than existing techniques when used on comparatively large datasets, while allowing for mitigation of the noise introduced to outlier data.

The present disclosure addresses the deficiencies described above by providing a process (as well as a system, method, machine-readable medium, etc.) that generates, using a probability distribution of synthetic data, a first value of a utility measure function, and a second value of the utility measure function, a value of an optimization variable; computes, using the value of the optimization variable, a sampling weight; samples, according to the sampling weight, the synthetic data; and trains, using the sampled synthetic dataset, a machine learning model. Thus, the illustrative embodiments provide for post-processing differentially private synthetic data.

An illustrative embodiment receives private synthetic data, generated from a source dataset (i.e., real data as opposed to synthetic data) using a presently available differential privacy technique. Which presently available differential privacy technique is used does not matter to an embodiment. An embodiment also receives one or more utility measure functions, each specifying an intended characteristic of the private synthetic data. An embodiment also receives one or more utility measure function values. Each utility measure value is a value of a utility measure function, computed using a presently available differential privacy technique on the source dataset. A utility measure value need not be computed using the same differential privacy technique as the private synthetic data. Thus, utility measure values are goals to which private synthetic data output from an embodiment should conform. In the mathematical expressions described herein, there are K utility measure functions (where K is an integer greater than or equal to one. Each utility measure function k is represented by qₖ(X), where the source dataset includes a single record x=(x₁ . . . ,x_{d})∈X from each individual. Values of utility measure functions computed on the source dataset are denoted by a=(a₁, . . . ,aₖ).

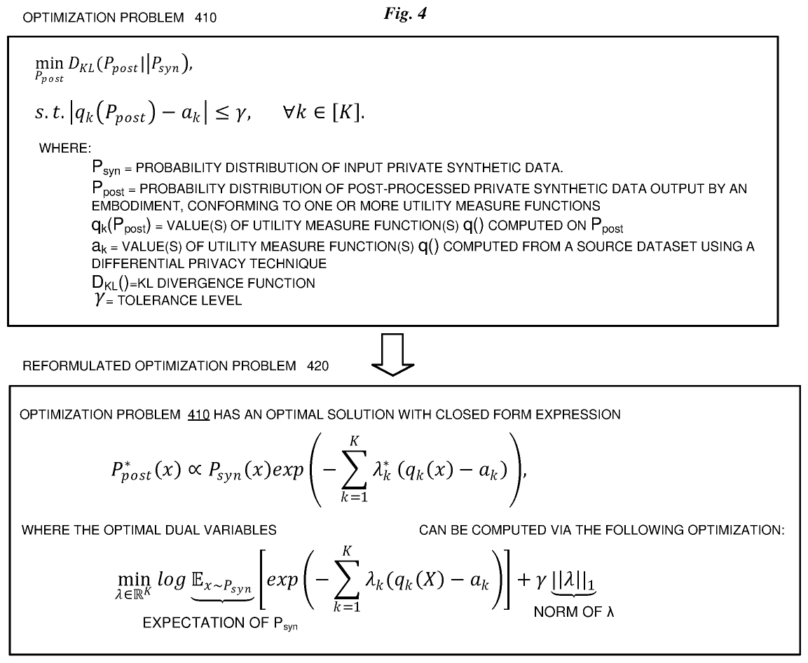

An embodiment uses a probability distribution of private synthetic data, a first value of a utility measure function, and a second value of the utility measure function to generate a value of an optimization variable. The first value of the utility measure function is computed on the source dataset using the differential privacy technique, and the second value of the utility measure function is computed on the synthetic data. In particular, if P_{syn} represents a probability distribution of input private synthetic data and Pₚₒₛₜ represents a probability distribution of post-processed private data (an output of an embodiment, conforming to one or more utility measure functions), an embodiment formulates an optimization problem, in which the objective function is to minimize a discrepancy, or distance, between Pₚₒₛₜ and P_{syn}, with constraints guaranteeing that the post-processed private data meet the utility measure functions up to a tolerance level greater than or equal to 0 and denoted by γ. This optimization problem is depicted as optimization problem 410 in FIG. 4, in which distance between Pₚₒₛₜ and P_{syn} is computed using KL-divergence, a presently available technique. However, the optimization problem as formulated becomes more difficult to solve as the number of features (i.e., columns in the input dataset) grows, as the number of variables grows exponentially with the number of features. Thus, an embodiment uses a reformulated optimization instead, depicted as reformulated optimization problem 420 in FIG. 4. Within reformulated optimization problem 420, the ∥ ∥₁ notation denotes computation of the L1 norm of a vector. The L1 norm is the sum of the absolute value of all of a vector's components. Specifically, for a vector with components (λ₁, . . . , λ_{K}), the vector's L1 norm is defined as |λ₁|+ . . . +|λ_{K}|. The dual variable(s) λ (a vector with K components) in the expressions are also referred to as optimization variables, and the number of optimization variables is equal to the number of utility measure functions.

An embodiment uses a presently available technique to denoise the first value(s) of the utility measure function (computed on the source dataset using a differential privacy technique, and denoted by aₖ in the depicted expressions) before using the denoised first value(s) to compute values of one or more optimization variables. One embodiment denoises the first value(s) by solving a linear program, while another embodiment denoises the first value(s) using a quadratic program, both presently available techniques

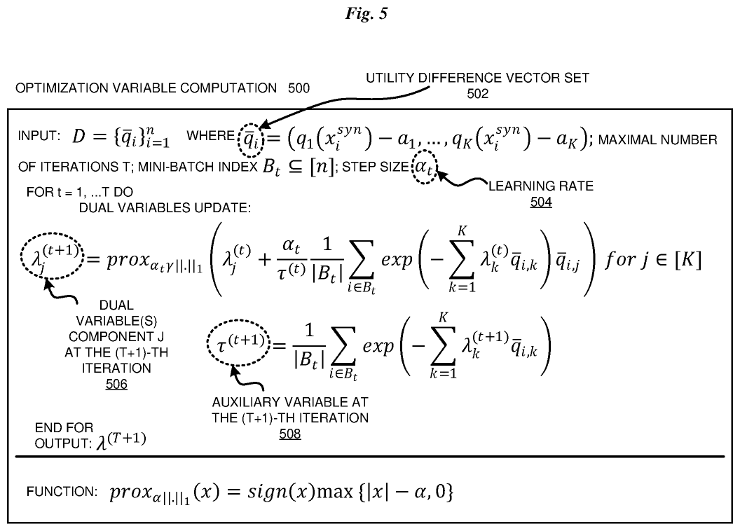

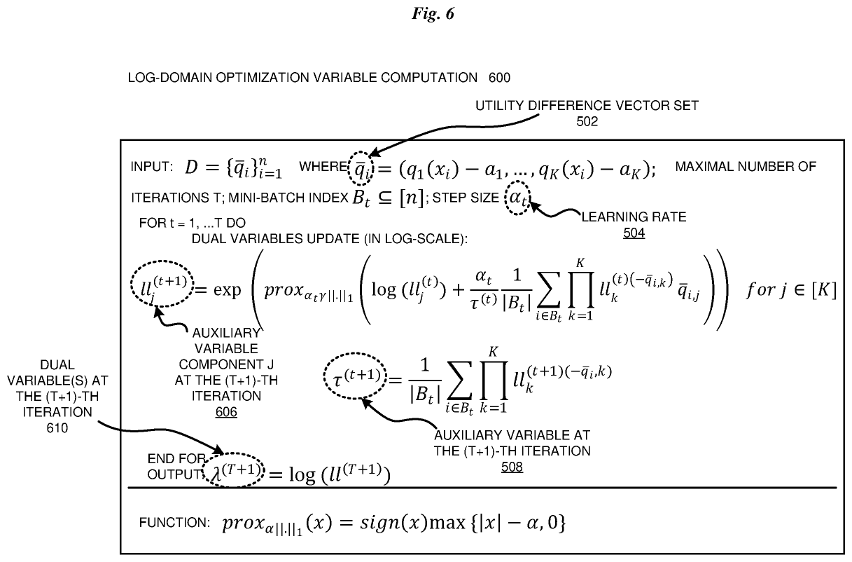

An embodiment generates one or more values of the optimization variables using the expression depicted as reformulated optimization problem 420 in FIG. 4. One embodiment generates one or more values of the optimization variables using the technique depicted in pseudocode in optimization variable computation 500 in FIG. 5. In the depicted technique, there are four inputs: (1) utility difference vector set bar (qᵢ), with each component representing the difference between the k-th utility measure of the i-th synthetic data point and its average counterpart from the source data; (2) the maximum number of iterations T; (3) mini-batch index Bₜ, which defines the data points to be used in the t-th iteration; and (4) step size αₜ, a hyperparameter governing the magnitude of updates to the optimization variable(s) in every iteration (often referred to as the learning rate). During each iteration, the computation selects a mini-batch of data from the utility difference vector set bar (qᵢ) based on the mini-batch index Bₜ, and uses this selected mini-batch to update both the dual variable(s) λ and auxiliary variable τ using the depicted expressions. In the depicted expressions, (t) and (t+1) represent a value of a variable at the t-th and (t+1)-th iterations. Additionally, αₜ denotes the step size at the t-th iteration and τ^{(t)} denotes the value of τ at the t-th iteration. Another embodiment, to avoid underflow and overflow problems, performs the computations in log-domain instead, using the technique depicted in log-domain optimization variable computation 600 in FIG. 6. In log-domain optimization variable computation 600, the inputs, outputs, and notation are the same as in optimization variable computation 500 in FIG. 5; however an additional auxiliary variable llⱼ (a vector with component j) is also used. Another embodiment uses another presently known technique to generates one or more values of the optimization variables.

An embodiment uses the value(s) of the optimization variable to compute corresponding sampling weight(s). A sampling weight is a probability of selecting a particular record (i.e., a portion of data) from the synthetic data. In particular, there are n sampling weights, where n denotes the number of records in the private synthetic data being sampled. One embodiment constructs a function defined by computing a sum, for j=1 to K, of λⱼ*(qⱼ(x)−aⱼ), and computing e raised to a negative of the sum, with λⱼ, qⱼ(x), and aⱼ as defined elsewhere herein. An embodiment applies the function to a synthetic data point, or record (denoted by x) in the private synthetic dataset, and the result of each application becomes a sampling weight for that record.

An embodiment samples the synthetic data according to the computed sampling weight(s). Thus, a record with a higher sampling weight will more likely to be sampled (or possibly be sampled multiple times), and a record with a lower sampling weight will be less likely to be sampled, and thus removed from the sampled synthetic dataset. As a result, the sampled synthetic dataset has a characteristic that matches a first characteristic of the source dataset within a tolerance, where the characteristic is measured according to an input utility measure function.

An embodiment trains, using the sampled synthetic dataset, a machine learning model. Another embodiment sends the sampled synthetic dataset to an existing model training implementation, such as a standardized pipeline, and causes training of a machine learning model using the sampled synthetic dataset.

A correlation matrix is a table that shows the correlation coefficients between pairs of features (i.e., columns) of input data. A correlation matrix is often used as a reference when selecting features for use in machine learning model training. In one use case, an embodiment improves alignment between the correlation matrix of the sampled synthetic dataset and the real data, by using the first-order moment of one or more features, or columns, and second-order moments of one or more pairs of features, or columns, as utility measure functions, thus improving model training using the sampled synthetic dataset. First and second order moments are presently known. In particular, if the dataset includes d features x₁, . . . , x_{d} for each record, then the first-order moment utility measure functions are x₁, . . . , x_{d}, and the second-order moment utility measure functions are xᵢ xⱼ for 1<=i<=j<=d.

Some differential privacy mechanisms introduce more noise to sparsely sampled data regions than to data regions with higher sample density, potentially resulting in inaccurate training of models using the noisy data. Thus, in one use case, an embodiment uses one or more presently known group fairness metrics as utility measure functions, thus mitigating data biases by filtering out synthetic data that does not accurately represent real data.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

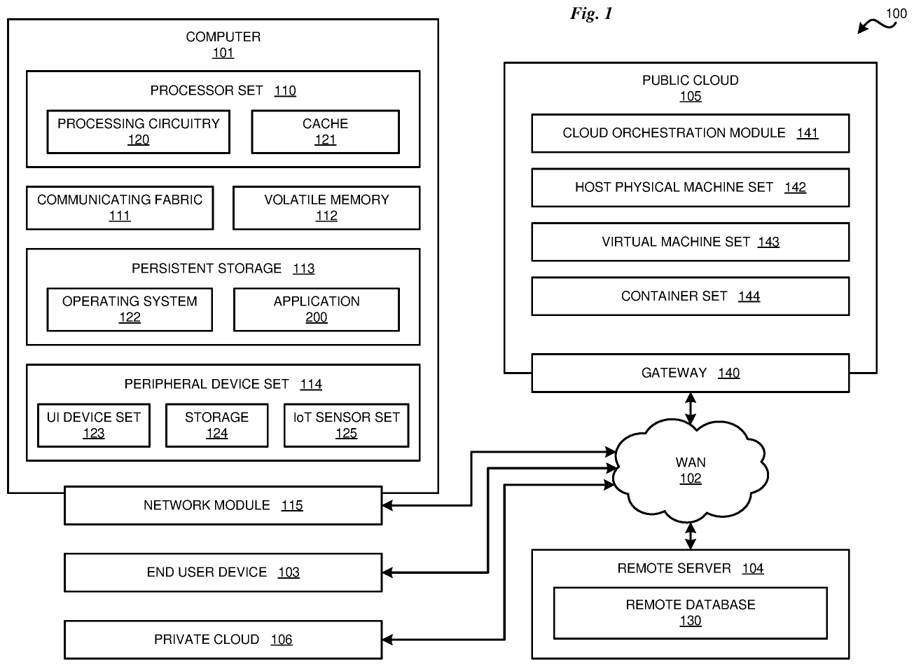

With reference to FIG. 1, this figure depicts a block diagram of a computing environment 100. Computing environment 100 contains an example of an environment for the execution of at least some of the computer code involved in performing the inventive methods, such as a module 200 implementing post-processing differentially private synthetic data. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

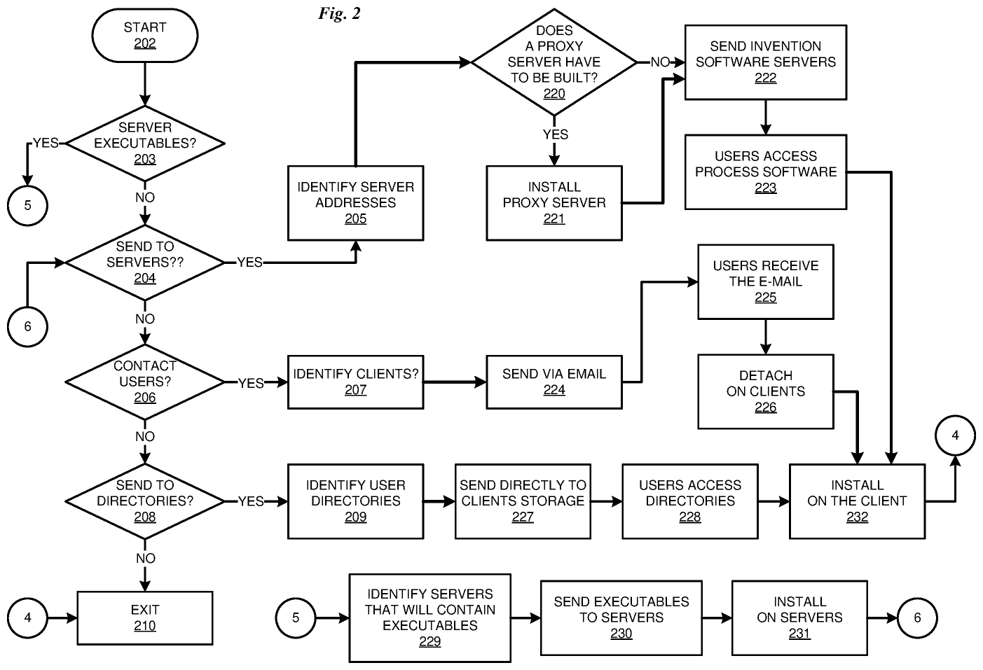

With reference to FIG. 2, this figure depicts a flowchart of an example process for loading of process software in accordance with an illustrative embodiment. The flowchart can be executed by a device such as computer 101, end user device 103, remote server 104, or a device in private cloud 106 or public cloud 105 in FIG. 1.

While it is understood that the process software implementing post-processing differentially private synthetic data may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 202 begins the deployment of the process software. An initial step is to determine if there are any programs that will reside on a server or servers when the process software is executed (203). If this is the case, then the servers that will contain the executables are identified (229). The process software for the server or servers is transferred directly to the servers' storage via FTP or some other protocol or by copying though the use of a shared file system (230). The process software is then installed on the servers (231).

Next, a determination is made on whether the process software is to be deployed by having users access the process software on a server or servers (204). If the users are to access the process software on servers, then the server addresses that will store the process software are identified (205).

A determination is made if a proxy server is to be built (220) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (221). The process software is sent to the (one or more) servers either via a protocol such as FTP, or it is copied directly from the source files to the server files via file sharing (222). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (223). Another embodiment is to have the servers automatically copy the process software to each client and then run the installation program for the process software at each client computer. The user executes the program that installs the process software on his client computer (232) and then exits the process (210).

In step 206 a determination is made whether the process software is to be deployed by sending the process software to users via e-mail. The set of users where the process software will be deployed are identified together with the addresses of the user client computers (207). The process software is sent via e-mail to each of the users' client computers (224). The users then receive the e-mail (225) and then detach the process software from the e-mail to a directory on their client computers (226). The user executes the program that installs the process software on his client computer (232) and then exits the process (210).

Lastly, a determination is made on whether the process software will be sent directly to user directories on their client computers (208). If so, the user directories are identified (209). The process software is transferred directly to the user's client computer directory (227). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (228). The user executes the program that installs the process software on his client computer (232) and then exits the process (210).

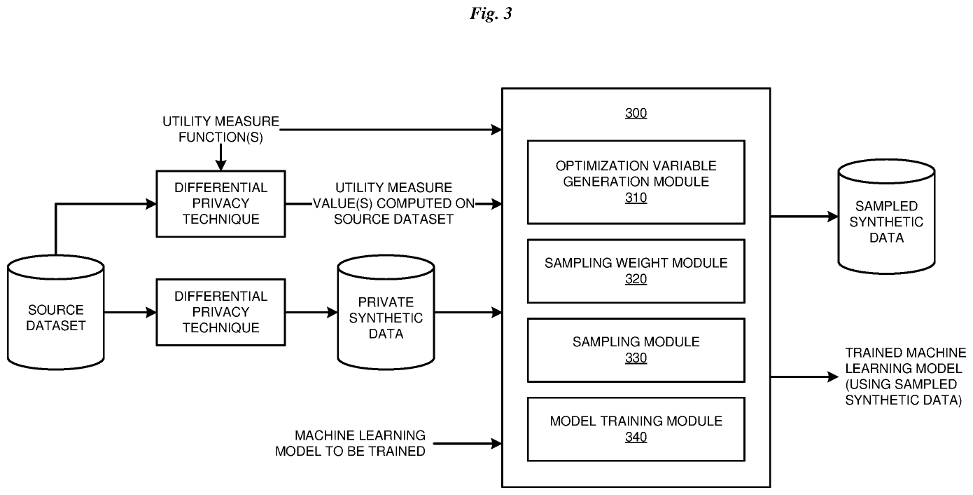

With reference to FIG. 3, this figure depicts a block diagram of an example configuration for post-processing differentially private synthetic data in accordance with an illustrative embodiment. Application 300 is the same as application 200 in FIG. 1.

In the illustrated embodiment, application 300 receives private synthetic data, generated from a source dataset (i.e., real data as opposed to synthetic data) using a presently available differential privacy technique. Application 300 also receives one or more utility measure functions, each specifying an intended characteristic of the private synthetic data. Application 300 also receives one or more utility measure function values. Each utility measure value is a value of a utility measure function, computed using a presently available differential privacy technique on the source dataset. A utility measure value need not be computed using the same differential privacy technique as the private synthetic data. Thus, utility measure values are goals to which private synthetic data output from an embodiment should conform. In the mathematical expressions described herein, there are K utility measure functions (where K is an integer greater than or equal to one. Each utility measure function k is represented by qₖ(X), where the source dataset includes a single record x=(x₁ . . . x_{d})∈X from each individual. Values of utility measure functions computed on the source dataset are denoted by a=(a₁, . . . ,a_{K}).

Optimization variable generation module 310 uses a probability distribution of private synthetic data, a first value of a utility measure function, and a second value of the utility measure function to generate a value of an optimization variable. The first value of the utility measure function is computed on the source dataset using the differential privacy technique, and the second value of the utility measure function is computed on the synthetic data. In particular, if P_{syn} represents a probability distribution of input private synthetic data and Pₚₒₛₜ represents a probability distribution of post-processed private data (an output of application 300, conforming to one or more utility measure functions), module 310 formulates an optimization problem, in which the objective function is to minimize a discrepancy, or distance, between Pₚₒₛₜ and P_{syn}, with constraints guaranteeing that the post-processed private data meet the utility measure functions up to a tolerance level greater than or equal to 0 and denoted by γ. This optimization problem is depicted as optimization problem 410 in FIG. 4, in which distance between Pₚₒₛₜ and P_{syn} is computed using KL-divergence, a presently available technique. However, the optimization problem as formulated becomes more difficult to solve as the number of features (i.e., columns in the input dataset) grows, as the number of variables grows exponentially with the number of features. Thus, module 310 uses a reformulated optimization instead, depicted as reformulated optimization problem 420 in FIG. 4. Within reformulated optimization problem 420, the ∥ ∥₁ notation denotes computation of the L1 norm of a vector. The L1 norm is the sum of the absolute value of all of a vector's components. Specifically, for a vector with components (λ₁, . . . , λ_{K}), the vector's L1 norm is defined as |λ₁|+ . . . +|λ_{K}|. The dual variable(s) λ (a vector with K components) in the expressions are also referred to as optimization variables, and the number of optimization variables is equal to the number of utility measure functions.

Module 310 uses a presently available technique to denoise the first value(s) of the utility measure function (computed on the source dataset using a differential privacy technique, and denoted by aₖ in the depicted expressions) before using the denoised first value(s) to compute values of one or more optimization variables. One implementation of module 310 denoises the first value(s) by solving a linear program, while another embodiment denoises the first value(s) using a quadratic program.

Module 310 generates one or more values of the optimization variables using the expression depicted as reformulated optimization problem 420 in FIG. 4. One implementation of module 310 generates one or more values of the optimization variables using the technique depicted in pseudocode in optimization variable computation 500 in FIG. 5. In the depicted technique, there are four inputs: (1) utility difference vector set bar (qᵢ), with each component representing the difference between the k-th utility measure of the i-th synthetic data point and its average counterpart from the source data; (2) the maximum number of iterations T; (3) mini-batch index Bₜ, which defines the data points to be used in the t-th iteration; and (4) step size αₜ, a hyperparameter governing the magnitude of updates to the optimization variable(s) in every iteration (often referred to as the learning rate). During each iteration, the computation selects a mini-batch of data from the utility difference vector set bar (qᵢ) based on the mini-batch index Bₜ, and uses this selected mini-batch to update both the dual variable(s) λ and auxiliary variable τ using the depicted expressions. In the depicted expressions, (t) and (t+1) represent a value of a variable at the t-th and (t+1)-th iterations. Additionally, αₜ denotes the step size at the t-th iteration and τ^{(t)} denotes the value of t at the t-th iteration. Another implementation of module 310, to avoid underflow and overflow problems, performs the computations in log-domain instead, using the technique depicted in log-domain optimization variable computation 600 in FIG. 6. In log-domain optimization variable computation 600, the inputs, outputs, and notation are the same as in optimization variable computation 500 in FIG. 5; however an additional auxiliary variable llⱼ (a vector) is also used. Another implementation of module 310 uses another presently known technique to generates one or more values of the optimization variables.

Sampling weight module 320 uses the value(s) of the optimization variable to compute corresponding sampling weight(s). A sampling weight is a probability of selecting a particular record (i.e., a portion of data) from the synthetic data. In particular, there are n sampling weights, where n denotes the number of records in the private synthetic data being sampled. One implementation of module 320 constructs a function defined by computing a sum, for j=1 to K, of λⱼ*(qⱼ(x)−aⱼ), and computing e raised to a negative of the sum, with λⱼ, qⱼ(x), and aⱼ as defined elsewhere herein. Module 320 applies the function to a synthetic data point, or record (denoted by x) in the private synthetic dataset, and the result of each application becomes a sampling weight for that record.

Sampling module 330 samples the synthetic data according to the computed sampling weight(s). Thus, a record with a higher sampling weight will more likely to be sampled (or possibly be sampled multiple times), and a record with a lower sampling weight will be less likely to be sampled, and thus removed from the sampled synthetic dataset. As a result, the sampled synthetic dataset has a characteristic that matches a first characteristic of the source dataset within a tolerance, where the characteristic is measured according to an input utility measure function.

Model training module 340 trains, using the sampled synthetic dataset, a machine learning model. Another implementation of module 340 sends the sampled synthetic dataset to an existing model training implementation, such as a standardized pipeline, and causes training of a machine learning model using the sampled synthetic dataset.

With reference to FIG. 4, this figure depicts optimization problems for use in post-processing differentially private synthetic data in accordance with an illustrative embodiment. In particular, the optimization problems can be used by optimization variable generation module 310 in FIG. 3.

In the depicted optimization problem 410, the objective function is to minimize a discrepancy, or distance, between Pₚₒₛₜ and P_{syn}, with constraints guaranteeing that the post-processed private data meet the utility measure functions up to a tolerance level greater than or equal to 0 and denoted by γ. A distance between Pₚₒₛₜ and P_{syn} is computed using KL-divergence, a presently available technique. Reformulated optimization problem 420 depicts a reformulated version of problem 410. Within reformulated optimization problem 420, the ∥ ∥₁ notation denotes computation of the L1 norm of a vector. The L1 norm is the sum of the absolute value of all of a vector's components. Specifically, for a vector with components (λ₁, . . . , λ_{K}), the vector's L1 norm is defined as |λ₁|+ . . . +|λ_{K}|. The dual variable(s) λ (a vector with K components) in the expressions are also referred to as optimization variables, and the number of optimization variables is equal to the number of utility measure functions.

With reference to FIG. 5, this figure depicts a computation technique for use in post-processing differentially private synthetic data in accordance with an illustrative embodiment. In particular, the computation technique can be used by optimization variable generation module 310 in FIG. 3.

In particular, optimization variable computation 500 depicts a technique usable by module 310 to generate one or more values of the optimization variables. In the depicted technique, there are four inputs: (1) utility difference vector set 502 (bar (qᵢ)), with each component representing the difference between the k-th utility measure of the i-th synthetic data point and its average counterpart from the source data; (2) the maximum number of iterations T; (3) mini-batch index Bₜ, which defines the data points to be used in the t-th iteration; and (4) step size at (learning rate 504), a hyperparameter governing the magnitude of updates to the optimization variable(s) in every iteration. During each iteration, the computation selects a mini-batch of data from the utility difference vector set 502, based on the mini-batch index Bₜ, and uses this selected mini-batch to update both the dual variable(s) λ (506) and auxiliary variable t (508) using the depicted expressions. In the depicted expressions, (t) and (t+1) represent a value of a variable at the t-th and (t+1)-th iterations. Additionally, αₜ denotes the step size at the t-th iteration and τ^{(t)} denotes the value of t at the t-th iteration.

With reference to FIG. 6, this figure depicts another computation technique for use in post-processing differentially private synthetic data in accordance with an illustrative embodiment. In particular, the computation technique can be used by optimization variable generation module 310 in FIG. 3. Utility difference vector set 502, learning rate 504, and 508 are the same as utility difference vector set 502, learning rate 504, and 508 in FIG. 5.

In particular, optimization variable computation 600 depicts a technique usable by module 310 to generate one or more values of the optimization variables. In the depicted technique, there are four inputs: (1) utility difference vector set 502 (bar(qᵢ)), with each component representing the difference between the k-th utility measure of the i-th synthetic data point and its average counterpart from the source data; (2) the maximum number of iterations T; (3) mini-batch index Bₜ, which defines the data points to be used in the t-th iteration; and (4) step size at (learning rate 504), a hyperparameter governing the magnitude of updates to the optimization variable(s) in every iteration. During each iteration, the computation selects a mini-batch of data from the utility difference vector set 502, based on the mini-batch index Bₜ, and uses this selected mini-batch to update both the auxiliary variable(s) λ (606) and auxiliary variable τ (508) using the depicted expressions. After the iterations, dual variable(s) 610 are computed. In the depicted expressions, (t) and (t+1) represent a value of a variable at the t-th and (t+1)-th iterations. Additionally, αₜ denotes the step size at the t-th iteration and τ^{(t)} denotes the value of t at the t-th iteration.

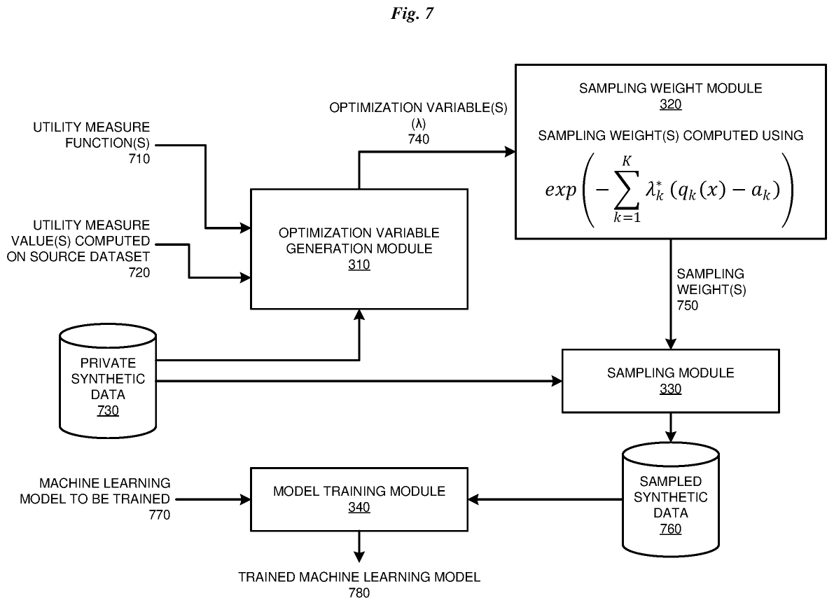

With reference to FIG. 7, this figure depicts an example of post-processing differentially private synthetic data in accordance with an illustrative embodiment. The example can be executed using application 300 in FIG. 3.

As depicted, optimization variable generation module 310 uses a probability distribution of private synthetic data 730, utility measure function value(s) 720 (computed on the source dataset using a differential privacy technique), and a value of utility measure function 710 (computed on private synthetic data 730) to generate value(s) of an optimization variable 740. Sampling weight module 320 uses value(s) 740 to compute corresponding sampling weight(s) 750. Sampling module 330 samples private synthetic data 730 according to the computed sampling weight(s) 750, resulting in sampled synthetic data 760. Model training module 340 uses sampled synthetic data 760 to train machine learning model 770, resulting in trained machine learning model 780.

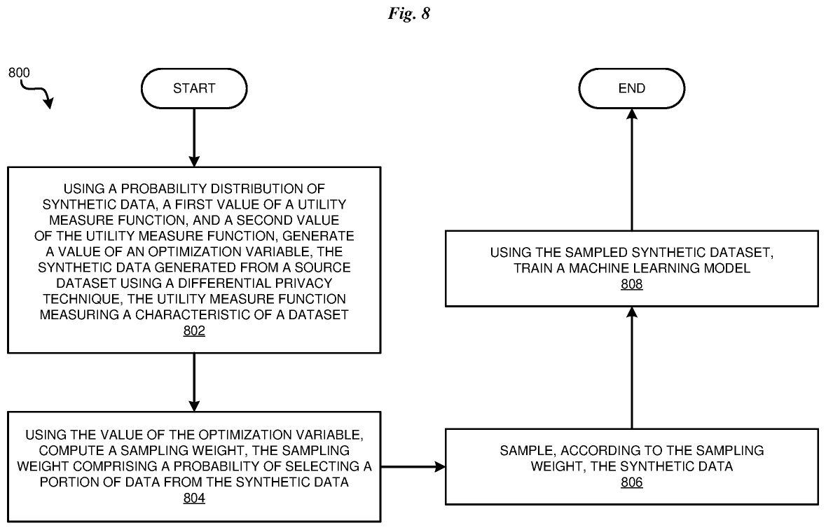

With reference to FIG. 8, this figure depicts a flowchart of an example process for post-processing differentially private synthetic data in accordance with an illustrative embodiment. Process 800 can be implemented in application 200 in FIG. 3.

In the illustrated embodiment, at block 802, the process, using a probability distribution of synthetic data, a first value of a utility measure function, and a second value of the utility measure function, generates a value of an optimization variable, the synthetic data generated from a source dataset using a differential privacy technique, the utility measure function measuring a characteristic of a dataset. At block 804, the process, using the value of the optimization variable, computes a sampling weight, the sampling weight comprising a probability of selecting a portion of data from the synthetic data. At block 806, the process samples, according to the sampling weight, the synthetic data. At block 808, the process, using the sampled synthetic dataset, trains a machine learning model. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
generating, using a probability distribution of synthetic data, a first value of a utility measure function, and a second value of the utility measure function, a value of an optimization variable, the synthetic data generated from a source dataset using a first differential privacy technique, the utility measure function measuring a characteristic of a dataset;
computing, using the value of the optimization variable, a sampling weight, the sampling weight comprising a probability of selecting a portion of data from the synthetic data;
sampling, according to the sampling weight, the synthetic data, the sampling resulting in a sampled synthetic dataset; and
training, using the sampled synthetic dataset, a machine learning model, the training resulting in a trained machine learning model.

2. The computer-implemented method of claim 1, wherein the first value of the utility measure function is computed on the source dataset using a second differential privacy technique.

3. The computer-implemented method of claim 1, wherein the second value of the utility measure function is computed on the synthetic data.

4. The computer-implemented method of claim 1, wherein the value of the optimization variable is generated by solving an optimization problem.

5. The computer-implemented method of claim 1, wherein the utility measure function is part of a set of utility measure functions, the optimization variable is part of a set of optimization variables, and the set of utility measure functions has the same number of members as the set of optimization variables.

6. The computer-implemented method of claim 1, wherein the sampled synthetic dataset has a first characteristic that matches a first characteristic of the source dataset within a tolerance, the first characteristic measured according to the utility measure function.

7. A computer program product comprising one or more computer readable storage media, and program instructions collectively stored on the one or more computer readable storage media, the program instructions executable by a processor to cause the processor to perform operations comprising:
generating, using a probability distribution of synthetic data, a first value of a utility measure function, and a second value of the utility measure function, a value of an optimization variable, the synthetic data generated from a source dataset using a first differential privacy technique, the utility measure function measuring a characteristic of a dataset;
computing, using the value of the optimization variable, a sampling weight, the sampling weight comprising a probability of selecting a portion of data from the synthetic data;
sampling, according to the sampling weight, the synthetic data, the sampling resulting in a sampled synthetic dataset; and
training, using the sampled synthetic dataset, a machine learning model, the training resulting in a trained machine learning model.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, wherein the first value of the utility measure function is computed on the source dataset using a second differential privacy technique.

11. The computer program product of claim 7, wherein the second value of the utility measure function is computed on the synthetic data.

12. The computer program product of claim 7, wherein the value of the optimization variable is generated by solving an optimization problem.

13. The computer program product of claim 7, wherein the utility measure function is part of a set of utility measure functions, the optimization variable is part of a set of optimization variables, and the set of utility measure functions has the same number of members as the set of optimization variables.

14. The computer program product of claim 7, wherein the sampled synthetic dataset has a first characteristic that matches a first characteristic of the source dataset within a tolerance, the first characteristic measured according to the utility measure function.

15. A computer system comprising a processor and one or more computer readable storage media, and program instructions collectively stored on the one or more computer readable storage media, the program instructions executable by the processor to cause the processor to perform operations comprising:
generating, using a probability distribution of synthetic data, a first value of a utility measure function, and a second value of the utility measure function, a value of an optimization variable, the synthetic data generated from a source dataset using a first differential privacy technique, the utility measure function measuring a characteristic of a dataset;
computing, using the value of the optimization variable, a sampling weight, the sampling weight comprising a probability of selecting a portion of data from the synthetic data;
sampling, according to the sampling weight, the synthetic data, the sampling resulting in a sampled synthetic dataset; and
training, using the sampled synthetic dataset, a machine learning model, the training resulting in a trained machine learning model.

16. The computer system of claim 15, wherein the first value of the utility measure function is computed on the source dataset using a second differential privacy technique.

17. The computer system of claim 15, wherein the second value of the utility measure function is computed on the synthetic data.

18. The computer system of claim 15, wherein the value of the optimization variable is generated by solving an optimization problem.

19. The computer system of claim 15, wherein the utility measure function is part of a set of utility measure functions, the optimization variable is part of a set of optimization variables, and the set of utility measure functions has the same number of members as the set of optimization variables.

20. The computer system of claim 15, wherein the sampled synthetic dataset has a first characteristic that matches a first characteristic of the source dataset within a tolerance, the first characteristic measured according to the utility measure function.
